(19) United States
(12) Patent Application Publication
(10) Pub. No.: US 2019/0164401 A1
(43) Pub. Date: May 30, 2019

(54) OBJECT TRACKING SYSTEM

(71) Applicant: Secure2Go Pty Ltd, South Perth (AU)

(72) Inventors: Wesley Lawrence, South Perth (AU); Quentin Rees Oliver, South Perth (AU); Ionut Bogdan Popescu, South Perth (AU)

(21) Appl. No.: 16/091,585

(22) PCT Filed: Nov. 1, 2016
(86) PCT No.: PCT/AU2016/051036

§ 371 Date: Oct. 5, 2018

(30) Foreign Application Priority Data
Apr. 5, 2016 (AU) 2016901257

(51) Int. Cl. G08B 21/02; H04W 4/029

(52) U.S. Cl. CPC G08B 21/0286; G01S 19/25; G08B 21/0269; H04W 4/029

(57) ABSTRACT

An object tracking system comprising at least one object to be tracked, a tracking device, a communication means, a central network system and a user operated device. Each of the objects to be tracked have location data detection means and is connected via the connection means with a communication network. The central network system is connected with the communication network and comprises an input means to receive the location data from the at least one object via the communication network, a relational database, a software engine and an output means to transmit data via the communication network. The at least one user operated display is connected to the communication network and is configured to display information relating to the data transmitted from the central network system.

### TECHNICAL FIELD

The present invention is generally directed to network connected wearable and carryable devices and systems. More specifically, the invention is directed to a software application to facilitate monitoring and tracking a network of connected wearable and carryable devices.

### BACKGROUND

There are many occasions where it is important to record the movement of objects, and to be able to generally track locational information of an object within a defined area. This has conventionally been done through manual systems, which include paper-based sign-in/sign-out systems as well as more technologically advanced systems involving RFID cards and the like. However, these systems are predominantly manual, and require some level of manual recording the movements of an object within a particular location. These methods of tracking require a high level of fidelity on the part of the individual in order to be accurate.

Manual tracking methods may have ‘blind spots’ where there is insufficient information available to accurately track the movement of an object. Manual tracking methods can also introduce a time delay in the transmission of information, which is undesirable because in many situations, it can be critical to reduce the time delay down to the minimum.

A number of wearable and carryable ‘smart’ devices exist that are capable of providing accurate, real-time movement records for the device, and, by extension, for individuals in possession of the device and objects that are associated with the device. However, these devices by and large do not communicate with one another, which makes it difficult to track a number of different objects, particularly where each of the objects utilise, or are associated with different ‘smart’ devices.

It would therefore be desirable for a system to connect with any type of wearable or carryable ‘smart’ device to enable a these devices to be centrally tracked and provide accurate, real-time movement records for any object associated with a device within a network.

### SUMMARY OF INVENTION

The advantages of the present invention are provided, in one broad form, by an object tracking system which comprises at least one object to be tracked, at least one tracking device associated with each of the at least one objects, each of the tracking devices having location data detection means and connected via at least one connection means with a communication network, a central network system connected with the communication network, and at least one user operated display connected to the communication network and configured to display information relating to the data transmitted from the central network system, wherein the communication network comprises an input means to receive the location data from the at least one tracking device via the communication network, a relational database, a software engine and an output means to transmit data via the communication network.

In an embodiment, the user operated display is adapted to receive user input commands and can transmit these user input commands via the communication network to the central network system. In an embodiment, the central network system requires an Identity Verification Protocol to be inputted by the user of the user operated display prior to provision of the time-dependent locational data of the tracking device.

In an embodiment, the object tracking system comprises multiple user operated displays. In an embodiment, each user operated display may be adapted to receive and display locational data associated with the object being tracked, independent of the other user operated displays.

In an embodiment, the at least one tracking device may additionally comprise one or more further devices. In an embodiment, at least one of the further devices is adapted to monitor additional parameters associated with the object being tracked. In an embodiment, the further device adapted to monitor additional parameters may be further adapted to receive input from at least one electronic system integrated into the object being tracked.

In an embodiment, at least one of the further devices may comprise one or more alarm systems. In an embodiment, the alarm system may comprise at least one input means and at least one output means which comprises at least one form of local alarm. In an embodiment, upon receiving a signal through the input means, the alarm system may provide an activating signal to the output means, activating at least one of the local alarms. In an embodiment, at least one of the local alarms is an audible alarm. In an embodiment, at least one of the local alarms is a visible alarm. In an embodiment, the input means associated with the alarm may comprise at least one further device adapted to monitor additional parameters associated with the object being tracked.

In an embodiment, the user operated display comprises a particular device architecture. In an embodiment, the central network system at least partially comprises modular service architecture. In an embodiment, the central network system is adapted to selectively activate and deactivate individual modules of the modular service architecture in order to adapt to the particular device architecture of the user operated display. In an embodiment, the modular service architecture is microservice architecture.

In an embodiment wherein the communication network comprises a plurality of independent communication networks, the connection means may be able to connect to each of the plurality of independent communication networks. In an embodiment, the connection means is further adapted so as to automatically connect to the strongest signal available. In an embodiment, the tracking device is adapted to transmit an alarm to the user operated display in the event of an attempt to disable or otherwise damage the tracking device, or an attempt to disable, damage or remove the ability of the tracking device to track the object to be tracked.

In operation, data recorded by the tracking device may be transmitted to the central network system via the communication network. In an embodiment, this data is stored on the database as data describing location and time. The interpretive software of the central network system interprets the stored data and transmits this via a further conventional communication network to the user operated display. The user operated display displays the time-dependent locational data associated with a particular tracking device in a manner adapted for ease of interpretation by a user. In an embodiment, the user operated display is further capable of receiving input from the user of said user operated display and transmitting this via the further communication network to the central network system.

### BRIEF DESCRIPTION OF THE DRAWINGS

The invention is shown in in a number of non-limiting drawings in which:

FIG. 1 is a block diagram showing the elements of the object tracking system of the present invention;

FIG. 2 is a schematic diagram showing the elements of the object tracking system shown in FIG. 1, showing the use of terrestrial wireless networks to aid in determining locational information;

FIG. 3 is a block diagram showing the connection means of the object tracking system of the present invention;

FIG. 4 is a block diagram of the object tracking system comprising additional further devices; and

FIG. 5 is a schematic diagram showing the elements of the object tracking system shown in FIG. 1, incorporating microservice architecture utilised in the central network.

### BEST MODE FOR CARRYING OUT THE INVENTION

The object tracking system of the current invention connects wearable or carryable tracking devices over a central network system via one of a plurality of wireless connection means to.

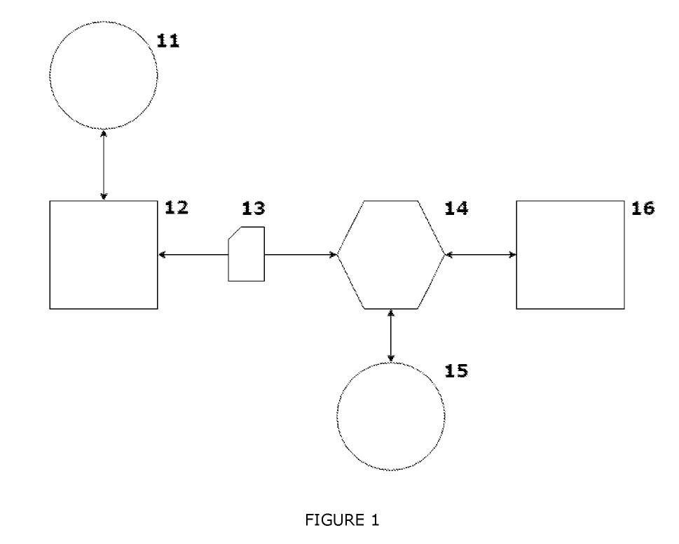

With reference to FIG. 1, the object tracking system typically comprises at least one object 12 to be tracked that is in communication with a central network system 15 via one or more communication networks 14. The central network system 15 is additionally in communication with at least one user operated display 16, wherein the communication is again facilitated by the one or more communication networks 14. The communication network 14 between the object to be tracked 12 and the central network system 15 may comprise either the same or different forms of communication networks as between the central network system 15 and the user operated display 16.

The central network system 15 includes an input means to receive location data from the tracking device 12 via the communication network 14, a relational database to identify information about the tracking device, a software engine to process the information relating to the tracking device, and an output means to transmit data to at least one user operated display via the communication network. The locational data may be recorded in a variety of manners such as latitude/longitude, street address and other forms. The locational data may include further data such as data associated with change in location, including speed, distance travelled within a period of time, direction of travel and other factors that may influence a change in location.

The locational data is furthermore not necessarily limited to two dimensions; where possible and practical, it may be of value to record, for example, the altitude of the tracking device.

The relational database is typically adapted in order to recognise the data of the object to be tracked 12, as well as to collate and store the data in a given location associated with the tracking device, and to ensure that the data is only transmitted to the correct user operated display or displays 16. The relational database may further serve to ensure that only particular user operated displays 16 are capable of transmitting commands in one form or another to the tracking device.

The central network system 15 is preferably cloud-based so as to provide stability to the monitoring of the tracking device 12 as well as to provide accessibility by a user operated display 16 anywhere in the world.

The at least one user operated display 16 is connected to the communication network 14 and is configured to display information relating to the data transmitted from the central network system 15. The user operated display 16 comprises a display screen capable of displaying data in a visual form that is received from the central network system 15 via the communication network 14. The user operated display 16 may further comprise input means by which the user may input commands or variables to be relayed via the communication network to one or more of the tracking device and the central network system. The user operated display 16 may be a handheld device, such as a smart device, or may be a larger device such as a laptop or desktop computer.

In an embodiment of the invention, a single user operated display 16 may be associated with a plurality of tracking devices 12. In an embodiment, a single tracking device 12 may provide locational data (as well as other additional data) to a plurality of user operated displays 16. Any variation thereof—such as multiple tracking devices 12 and multiple user operated displays 16 communicating with one another—is also considered to be within the scope of the invention as described herein.

In accordance with a preferred embodiment of the present invention, each tracking device 12 includes a GPS device to provide the location data associated with the tracking device. A GPS receiver in each of the tracking devices determines the geographic location of an object associated with the tracking device using signals from GPS satellites 11. The global positioning system comprises a constellation of twenty four satellites 11 for providing coded signal coverage throughout the world at a frequency of 1574.42 mega-Hertz (MHz). The GPS receiver in the tracking device 12 receives and processes the coded signals from at least four GPS satellites 11 to determine the location of an object associated with the tracking device (longitude, latitude, and altitude). However, the GPS receiver cannot effectively determine the location when the tracking device 12 is not in the direct line of sight from the GPS satellites 11. This may happen when the tracking device is indoors, surrounded by high rise buildings, or under a canopy of trees.

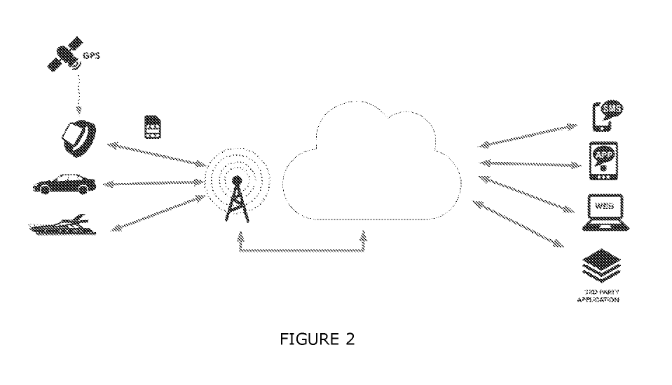

To circumvent these limitations of GPS, as best shown in FIG. 2, the tracking device may also include an AGPS device, which uses signals from GPS satellites 11 and signals from base stations in a terrestrial wireless communication network, which may also comprise base stations utilised in the communication network 14. When the tracking device 12 is in the lines of sight of the GPS satellites 11, it uses signals from both the GPS satellites 11 and the base stations to calculate its location. This will generally increase the accuracy of the tracking device 12. In addition, the AGPS device is capable of determining the location of the tracking device even when it is not in the lines of sight from GPS satellites 11. It does this by processing the signals from the base stations.

The communication network 14 may be any kind of wireless communication network. For example, the network may be a network dedicated for object tracking purpose. In a preferred embodiment, the network 14 is an existing cellular telephone network that provides coverage over a wide geographic area. A cellular telephone network typically includes base station controllers (BSC), and mobile switching centres (MSC). BSC and MSC serve to establish communication between the tracking device 12 and different base stations depending on the location of the tracking device 12 in the cellular network. Furthermore, the network may employ various kinds of multiple access standards for the multiple access of the network, e.g. time division multiple access (TDMA), frequency division multiple access (FDMA), code division multiple access (CDMA), a combination of different multiple access standards, etc.

In addition to the tracking devices including a GPS or AGPS receiver, the tracking device also comprises a number of other features that are designed to aid the longevity and independence of the tracking device. The tracking device is typically powered through a battery, which allows the object being tracked to be portable and not require an external power source for the tracking capabilities of the device.

The tracking devices also include a SIM card or a similar connection means 13 to connect the tracking device 12 with a communication network 14. The communication network 14 may be a partial or full deployment of most any telecommunication or computer network. As such, the communication network 14 may be a public or private, terrestrial wireless or satellite, and/or wireline telecommunications and/or computer network, which can be accessed using a SIM card or other like communication means 13. This connection means 13 is preferably designed to be difficult to remove from the tracking device or otherwise disable.

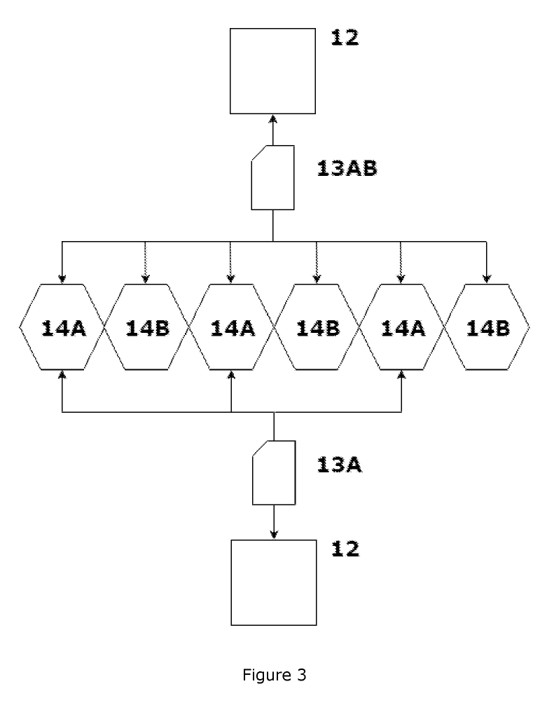

With reference to FIG. 3, the connection means 13AB is also preferably enabled for ‘roaming’ across multiple networks 14A, 14B. This extends the range in which the tracking device 12 will be operable, and enables tracking in zones where a particular communication network 14B is unavailable. A tracking device 12 provided solely with non-roaming connection means 13A is unable to connect to communication network 14B and so will not be able to transmit or receive any form of tracking signal when out of range of communication network 14A. Utilising a ‘roaming’ enabled connection means 13AB advantageously permits the tracking device 12 associated with an object, including a person, to be tracked in a various environments and regions, including across international boundaries. The roaming connection means 13AB also ensures that the tracking device 12 will automatically connect with the communication network 14A or 14B with the strongest and clearest cellular network frequency in the immediate area, which improves the clarity and fidelity of the tracking signal.

The central network system 15 of the present invention comprises an input means to receive the location data from the at least one object via the communication network 14. The input means is a receiver adapted to receive data over the communication network 14. Once the location data is received, the central network system 15 queries a relational database to determine information about the tracking device 12 for which the location data has been received. This information includes rules associated with the object location, which is associated with the tracking device 12. The software engine determines whether the location data requires data, such as an alert, to be transmitted by an output means via the communication network 14 to one or more user operated displays 16.

For example, where the object associated with the tracking device 12 is a tag (or other similar device) to be affixed to a child attending a child care facility, the input device of the central network system 15 may receive location data from the tracking device 12 via the communication network 14 when the child enters the child care facility (known as ‘signing in’).

In this example, the central network system 15 will then query the relational database to assess whether the child is registered to attend the child care facility on that day. The software engine then determines that the rule associated with the location data indicating that the child has been dropped off at the child care facility is to send a message to the user of the user operated display 16. The message transmitted to the user operated display may comprise additional messages, such as a reminder of the intended time for the child to be collected from the child care facility, for example.

In one embodiment, before any information is sent to the user operated display 16 by the central network system 15, the software engine will initiate an identity verification protocol. This identity verification protocol may take the form of the software engine sending a unique, algorithmically-generated identity key to the user operated display. In another embodiment, the user may provide personal information or a user-defined password to the software engine via the user operated display.

The central network system 15 is further preferably capable of receiving, recording and transmitting the location and other data in near-real-time. The central network system 15 may additionally be capable of two-way communication with the user operated display 16, which may be adapted to accept input from the user. For example, this may permit the user to define a location alarm, such that when a tracking device 12 is recorded by the central network system 15 as leaving or entering a particular area as defined by the user through the user operated display 16, the central network system 15 transmits an alarm to the user operated display 16 in order to alert the user.

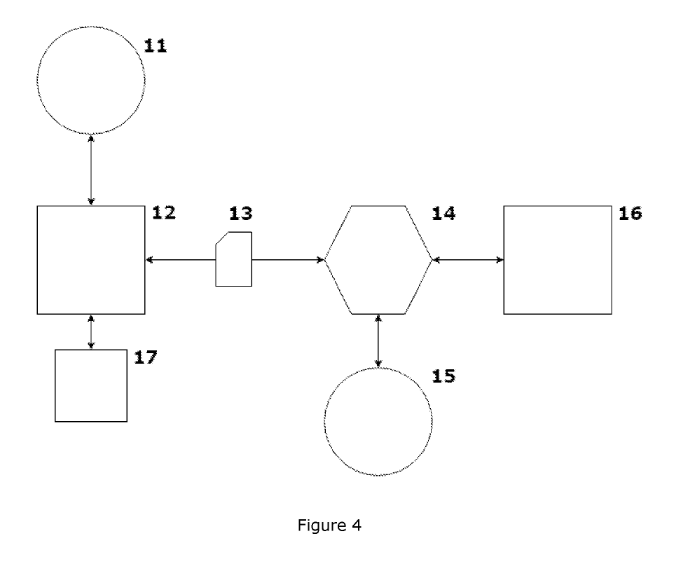

With reference to FIG. 4, the tracking device 12 may include further devices 17. The further devices 17 may additionally comprise other forms of industry-specific devices, which permits the object-tracking system to be adapted to a specific scenarios. These further devices may comprise local input means, enabling a person installing the tracking device 12 comprising at least one further device 17 to locally define inputs and/or outputs without the use of a separate user operated display 16. Alternatively, the further devices 17 may be in two-way communication with the user operated display 16 via the communication network 14, allowing the user of said user operated display 16 to alter the input and/or output variables associated with the further device 17 from a remote location.

In one embodiment, these further devices 17 may comprise monitoring devices to generate further information relating to the object associated with the tracking device. For example, the further monitoring devices can provide information relating to specific performance parameters of the object. For example, in an embodiment where the object being tracked is a child in a child care facility, the performance parameters may be how long the child spends in outdoor activities. In another embodiment where the object being tracked is a motor boat, the performance parameters may include information about the charge levels of the on board battery system. In one embodiment, the monitoring devices additionally comprise a user-defined input, wherein the user is able to define the parameters that are tracked by the monitoring devices.

In an embodiment, the further devices 17 may comprise alarm devices, wherein the type of alarm may be audible, visible or some other means of alarming or alerting a user. This embodiment is of particular applicability in scenarios such as construction sites, mine sites, debris fields and other scenarios wherein a user being tracked via the object tracking system may be in a dangerous environment. The alarm devices may have a number of triggers defined by the user of the user operated display 16. For example, locational alarms as defined by the user through the user operated display 16 may, upon activation, trigger an audible alarm in the tracking device 12 so as to alert the person wearing the tracking device that they are in an unsafe zone. Additionally, in the event of an accident, the further alarm devices may provide audible and/or visible alerts to aid others in pinpointing the exact location of the tracking device 12, permitting increased accuracy even beyond that afforded by GPS tracking via satellite systems 11.

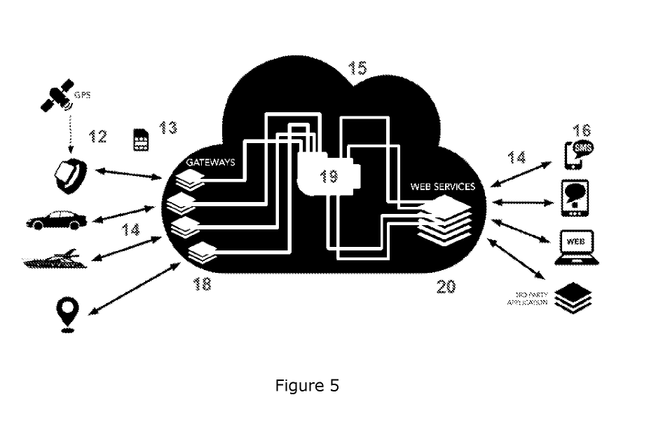

In an embodiment shown in FIG. 5, ‘microservice architecture’ is utilised within the central network system 15. In this embodiment, the central network system 15 is at least partially modular and is capable of activating or deactivating, as necessary, a plurality of individual services within each gateway 18 and web service 20 so as to adapt the central network system 15 to be compatible with a range of tracking devices 12 and user operated displays 16. Microservice architecture may be further utilised in order to increase the capacity of the central network system 15, increasing connectivity and stability of the central network system 15 when a large number of tracking devices 12 and/or user operated displays 16 are connected to the central network system 15.

Ordinary service architecture (occasionally referred to as ‘monolithic service architecture’) functions as a single, discrete application. This form of architecture cannot be readily adapted to interface with the internal device architecture of a range of different devices and therefore provide a service adapted to the needs and capabilities of each individual device. Microservice architecture, on the other hand, enables the division of the overall service into a series of multiple independent software applications, as shown by the multiple-layered form of the gateway services 18 and web services 20 in FIG. 5. In this manner, through enabling and disabling of individual service applications, the overall architecture of the system may be adapted to interface with the architecture of a range of devices. This allows for the user-operated display 16 to be one of any number of different types of devices, including for example, mobile phones, tablets, laptops, desktop computers, third party software or the like.

The multiple-layered nature of the microserivce architecture of the gateway services 18 and web services 20 further enables multiple tracking devices 12 and multiple user operated displays 16 to connect with the central network system 15 through the use of adaptive microservice architecture.

As a non-limiting example, a plurality of devices, each representing a separate user-operated display, may comprise a range of smart devices, tablets, laptops and desktop computers. The central network system 15 provides data to the user-operated display 16, and therefore the central network system 15, in this example, must be able to interface with each of the plurality of devices. A central network system 15 utilising traditional monolithic service architecture, however, is capable of receiving inputs and transmitting outputs in a limited range of forms. Therefore, only a certain range of devices, with matching device architecture, will be correctly adapted to provide inputs and outputs in the appropriate manner. Alternatively, a central network system 15 incorporating microservice architecture is able to intelligently adapt the overall presented service to correctly interface with a wider range and larger number of devices (including both tracking devices 12 and user operated displays 16), thereby extending the utility, adaptability and scalability of the system of the present invention.

### EXAMPLES

Child Tracking System

In one embodiment of the object tracking system, the object to be tracked is a child within a child care facility. In this scenario, the user is a parent, grandparent, childcare worker or other guardian of the child. A facility such as a childcare facility may be fitted with markers or alternatively has its geographical location defined via GPS. As such, upon the child arriving at the marked childcare facility, the child may be recorded by the system of the present invention as being “on-site”. The user may then monitor the child's location and status via the user-operated display. As multiple user-operated displays may be used, the guardians and childcare workers may separately monitor the child.

In the event of the child leaving the geographically-defined location of the childcare facility, an alarm may be transmitted to any number of user-operated displays so as to alert the user(s).

Preferably, the tracking device in this scenario is in the form of a watch-type or other wearable device. It is further preferably adapted so as to be difficult to remove or disable. The tracking device may be further adapted so as to immediately trigger one or more alarms upon attempt to remove, damage or disable the tracking device, preventing others from removing the child from the premises without alerting the users.

Hazardous Environment Personnel Tracking System

In an alternative embodiment, the object tracking system may be adapted for use in unsafe environments. These environments may be unsafe due to the presence of environmental hazards, construction, destruction, conflict or any other source of hazard. These hazards may additionally reduce or annul the ability of a person to utilise landmarks to identify their location.

In this scenario, the object to be tracked is typically a person, but may also be an animal such as a rescue animal, as is common in emergency rescue scenarios. As emergency rescue scenarios and other forms of emergency scenarios naturally take place in hazardous environments, the ability to electronically track the location and status of all personnel is of unparalleled value. In such a scenario, the tracking device may comprise additional further devices, for example to track various biometric values associated with the person being tracked. This may permit activation of at least one alarm in the event of the person being tracked becoming unable to voluntarily trigger an alarm. The means of tracking biometric values may comprise means such as heartbeat monitors, thermometers, respiration monitors and so on.

For adaptation to hazardous environments such as mine sites, refineries, and emergency scenarios such as firefighting the tracking device may further comprise one or more environmental sensors such as gas composition monitors, thermometers, Geiger counters and so on.

The tracking device may further comprise additional local alarms, permitting pinpoint location of a tracking device and the associated person in environments with reduced visibility. The local alarms may additionally serve to alert the person being tracked in the event that they move into an area defined as being beyond boundaries defined by the user via the user-operated device. The alarms may additionally be triggered by any of the other further devices associated with the tracking device.

Asset Tracking System

In this scenario, the tracking device is adapted to be affixed to an asset, vehicle or object that the user wishes to track. The combination of further devices may again be utilised to adapt the tracking device to the particular scenario. For example, a tracking device for a vehicle may additionally comprise a means of inputting the identity of the operator of a vehicle, permitting the user to track both the vehicle and the operator without requiring additional tracking devices. This further permits the user to track the skill, routes taken and incidents associated with individual operators.

In the scenario wherein the asset to be tracked is a vehicle such as a boat, the further devices may be adapted so as to monitor the connection between the boat and the shore. This further device, by monitoring the mooring state of the boat relative to the dock, would provide an early warning should a boat slip its moorings, as the drifting of the now-freed boat may not be immediate and thus will not trigger any locational alarms that may be programmed into the tracking device.

The further device can be additionally altered so as to interface with or otherwise receive input from the vehicle's electronics. This in turn allows for the further device to accept as an input any data that the vehicle itself may generate separate to the device. This input may provide additional outputs that are fed to other further devices integrated into the object tracking system, or may be relayed to the user output display via the communication network.

In this specification, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

### INDUSTRIAL APPLICABILITY

The present invention can be utilised where it is desirable to monitor a network of connected wearable, carryable and attachable devices, and particularly where it is desirable to provide notifications and alerts relating to the wearable and carryable devices via a communication network.

1. An object tracking system comprising:
at least one object to be tracked;
at least one tracking device associated with each of the at least one objects, each of the tracking devices having location data detection means and connected via at least one connection means with a communication network;
a central network system connected with the communication network comprising:
an input means to receive the location data from the at least one tracking device via the communication network;
a relational database;
a software engine; and
an output means to transmit data via the communication network;
the object tracking system comprising at least one user operated display connected to the communication network and configured to display information relating to the data transmitted from the central network system.

2. The object tracking system of claim 1, wherein the user operated display is adapted to receive user input commands and can transmit these user input commands via the communication network to the central network system.

3. The object tracking system of claim 2, wherein the central network system requires an Identity Verification Protocol to be inputted by the user of the user operated display prior to provision of the time-dependent location data of the tracking device.

4. The object tracking system of claim 1 comprising multiple user operated displays, where each user operated display is adapted to receive and display locational data associated with the object being tracked, independent of the other user operated displays.

5. The object tracking system of claim 1 wherein the at least one tracking device further comprises one or more further devices.

6. The object tracking system of claim 5 wherein at least one of the further devices comprises a device adapted to monitor additional parameters associated with the object being tracked.

7. The object tracking system of claim 6 wherein the further device adapted to monitor additional parameters is further adapted to receive input from at least one electronic system integrated into the object being tracked.

8. The object tracking system of claim 5 wherein at least one of the further devices comprises an alarm system, the alarm system comprising at least one input means and at least one output means comprising at least one form of local alarm;
wherein upon receiving a signal through the input means, the alarm system will provide an activating signal to the output means so as to activate at least one of the local alarms.

9. The object tracking system of claim 8 wherein at least one of the local alarms is an audible alarm.

10. The object tracking system of claim 8 wherein at least one of the local alarms is a visible alarm.

11. The object tracking system of claim 7 wherein the input means comprises a further device adapted to monitor additional parameters associated with the object being tracked.

12. The object tracking system of claim 1, wherein the communication network comprises a plurality of independent communication networks;
the connection means is able to connect to each of the plurality of independent communication networks; and
the connection means is further adapted so as to automatically connect to the strongest signal available.

13. The object tracking system of claim 1 wherein the user operated display comprises a particular device architecture;
the central network system at least partially comprises modular service architecture; and
the central network system is adapted to selectively activate and deactivate individual modules of the modular service architecture in order to adapt to the particular device architecture of the user operated display.

14. The object tracking system of claim 13 wherein the modular service architecture is microservice architecture.

15. The object tracking system of claim 1 wherein the tracking device is adapted to transmit an alarm to the user operated display in the event of an attempt to disable or otherwise damage the tracking device, or an attempt to disable, damage or remove the ability of the tracking device to track the object to be tracked.

16. The object tracking system of claim 1 wherein the tracking device is battery powered.
